(19) United States
(12) Patent Application Publication
(10) Pub. No.: US 2025/0282613 A1
(43) Pub. Date: Sep. 11, 2025

(54) MOLTEN SALT HEAT EXCHANGE SYSTEM FOR CONTINUOUS SOLAR PRODUCTION OF H2

(71) Applicant: Nant Holdings IP, LLC, Culver City, CA (US)

(72) Inventors: Nicholas J. Witchey, Culver City, CA (US); John Wiacek, Culver City, CA (US)

(73) Assignee: Nant Holdings IP, LLC, Culver City, CA (US)

(21) Appl. No.: 19/176,992

(22) Filed: Apr. 11, 2025

Related U.S. Application Data
(63) Continuation of application No. 16/578,012, filed on Sep. 20, 2019.
(60) Provisional application No. 62/734,751, filed on Sep. 21, 2018.

(51) Int. Cl. C01B 3/04; B01J 19/00; B01J 19/24; B01J 21/06; B01J 23/02; B01J 23/10; F24S 23/77

(52) U.S. Cl. CPC C01B 3/045; B01J 19/0013; B01J 19/2445; B01J 21/063; B01J 23/02; B01J 23/10; F24S 23/77; B01J 2219/00045; B01J 2219/00087

(57) ABSTRACT

Contemplated systems and methods for hydrogen production use a solar heliostat system as an energy source to produce hydrogen during daytime, and employ molten salt as an energy source to produce hydrogen during nighttime.

This application is a continuation of U.S. patent application Ser. No.: 16/578,012, filed on Sep. 20, 2019, which application claims priority to U.S. provisional patent application with the Ser. No. 62/734,751, which was filed Sep. 21, 2018, incorporated by reference herein.

### FIELD OF THE INVENTION

The field of the invention is clean energy technologies, especially as it relates to continuous production of hydrogen using solar energy.

### BACKGROUND OF THE INVENTION

The background description includes information that may be useful in understanding the present invention. It is not an admission that any of the information provided herein is prior art or relevant to the presently claimed invention, or that any publication specifically or implicitly referenced is prior art.

All publications and patent applications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

The use of hydrogen as an alternative fuel or power source is receiving wide attention, and there is a need for the efficient production of hydrogen for use as a fuel in both vehicular and stationary engines and fuel cell systems. Methods of generating hydrogen using solar energy to dissociate water are known in the art. For example U.S. Pat. No. 4,332,775 discloses use of concentrated solar radiation in a gas generator to produce hydrogen and oxygen from thermally dissociated water vapor. Similarly, U.S. Pat. No. 8,540,962 discloses a method for producing hydrogen by means of thermochemical water-splitting using solar energy obtained from a light collecting system.

However, these methods can only produce hydrogen during the day and during sunlight hours, and not during nighttime or on a cloudy and/or rainy day. Furthermore, because these methods only produce hydrogen during sunlight hours, a fair amount of energy is dissipated in heating up the hydrogen reactor each morning to a temperature of about 1000 to 2000° F., and cooling it back in the evening.

In recent years, methods of continuous production of hydrogen have been developed. For example, a continuous process was proposed that uses ceria particles, flowing through a receiver to be heated, on to tanks where the mass of sand-like particles can be stored, and then sent to particle conveyors which regulate the flow rate and thus control the temperatures at the step one and step two reactors (e.g., URL: https://phys.org/news/2018-05-solar-hydrogen-year.html). Still other processes are known in which solar heat is stored in molten salt to continuously drive a steam reformation reaction to produce hydrogen from methane. While conceptually attractive, such process will produce substantial quantities of CO₂, which is a known greenhouse gas.

Thus, even though various hydrogen production and energy storage systems are known in the art, there is still a need for continuous production of hydrogen while preventing undesirable byproducts.

### SUMMARY OF THE INVENTION

The inventive subject matter is directed to various systems and methods that allow for the continuous production of hydrogen by catalytic dissociation of steam using solar energy during both day and night time. Solar energy is used during the daytime by utilizing heat from a solar energy source to catalytically dissociate steam into H₂ and O₂ in a first catalytic reactor, while excess collected solar heat is stored in molten salt of a thermal energy storage circuit. During nighttime or during periods of low sunlight, such as foggy, cloudy, or rainy conditions, hydrogen is produced by utilizing heat from the thermal energy storage circuit to catalytically dissociate steam into H₂ and O₂.

In one aspect of the inventive subject matter, disclosed herein is a hydrogen production system, comprising: a first catalytic reactor and an optional second catalytic reactor that is operationally coupled to the first catalytic reactor; a thermal energy storage circuit; and a heat exchanger thermally coupled to the thermal energy storage circuit and the first and/or second catalytic reactor. The first catalytic reactor has a solar energy receiving portion and a first catalyst assembly that is capable of catalytically dissociating steam into H₂ and O₂. The optional second catalytic reactor has a second catalyst assembly that is capable of catalytically dissociating steam into H₂ and O₂. The heat exchanger is configured to provide thermal energy from the thermal energy storage circuit to the first and/or second catalytic reactor.

Where desirable, the hydrogen production system comprises both the first catalytic reactor and the second catalytic reactor. For example, the second catalytic reactor may receive thermal energy from the thermal energy storage circuit for catalytically dissociating steam into H₂ and O₂. In one preferred embodiment, the thermal energy storage circuit is operatively coupled to a solar energy receiver.

The thermal energy storage circuit may receive and store thermal energy from a variety of sources, such as for example, waste heat from a foundry, an oil refinery, a steelmaking plant, a power plant, a heated gas energy source, and/or a solar energy source. The thermal energy storage circuit may store the energy in various forms, for example, in hot molten salt. Of course, it should be appreciated at all forms and types of salt are contemplated, preferred embodiments include salts composed of alkaline earth fluorides and alkali metal fluorides, or combinations thereof.

In some embodiments, it is contemplated that the solar energy source that is configured to provide solar energy to both the solar energy receiving portion of the first catalytic reactor, as well as to the thermal energy storage circuit for heating the molten salt. The heat exchanger is configured to provide thermal energy at temperatures of 1000° F. to 2000° F. for dissociation of steam into H₂ and O₂.

The catalytic reactor in the hydrogen production system is contemplated to comprise a catalyst, such as for example, ceria or cerium dioxide (CeO₂), Strontium titanate (SrTiO₃), and/or Titanium dioxide (TiO₂).

In another aspect, provided herein is a method of continuously producing hydrogen, comprising: producing hydrogen during daytime by utilizing heat from a solar energy source to catalytically dissociate steam into H₂ and O₂ in a first catalytic reactor; and producing hydrogen during nighttime by utilizing heat stored in a thermal energy storage circuit to catalytically dissociate steam into H₂ and O₂.

Nighttime hydrogen production may be at the first catalytic reactor, in which case the heat stored in the thermal energy storage circuit is transferred to the first catalytic reactor by a heat exchanger. Alternatively, or additionally, nighttime hydrogen production may be in a second catalytic reactor, in which case the heat stored in the thermal energy storage circuit is transferred to the second catalytic reactor by a heat exchanger. In some embodiments, the heat exchanger is an integral part of the first and/or second catalytic reactor for heating steam to temperatures of 1000° F. to 2000° F.

In another aspect, disclosed herein is a method of producing H₂ gas, comprising: providing a solar heliostat system to produce H₂ gas, providing molten salt to capture waste heat from the solar heliostat system, and using the captured waste heat to produce H₂ gas when the sun is not available. This method is contemplated to continuously produce H₂ gas at temperatures between 1000° F. to 2000° F.

Various objects, features, aspects and advantages of the inventive subject matter will become more apparent from the following detailed description of preferred embodiments.

### BRIEF DESCRIPTION OF THE DRAWING

FIG. 1 illustrates an exemplary system for producing hydrogen.

FIG. 2 illustrates another exemplary system for producing hydrogen.

FIG. 3 illustrates another exemplary system for producing hydrogen.

### DETAILED DESCRIPTION

The inventive subject matter is directed to various systems and methods for continuous production of hydrogen. As is known in the art, hydrogen can be produced by splitting water (H₂O into H₂ and O₂) at very high temperatures using solar energy. While this process has the advantage of avoiding today's use of fossil fuels for hydrogen production, one downside is that this process can only be used during the daylight hours. When the catalytic reactor cools down at night or during low light conditions and when the catalytic reactor heats up when sufficient thermal energy is available, significant quantities of energy is lost during the cool-down and heat-up stages. Moreover, substantial greenhouse gas emissions are produced during heat-up using fossil energy sources.

The systems contemplated herein are advantageous over currently known hydrogen production systems because they produce clean hydrogen gas continuously (e.g., over a period of at least 16 hours, or more preferably at last 18 hours, or even more preferably at least 20 hours, and most preferably 22-24 hours per calendar day), without greenhouse exhausts. In preferred aspects, this is achieved by using a solar heliostat system to produce H₂ gas during daylight hours, and using molten salt to produce H₂ gas when sufficient solar energy is not available.

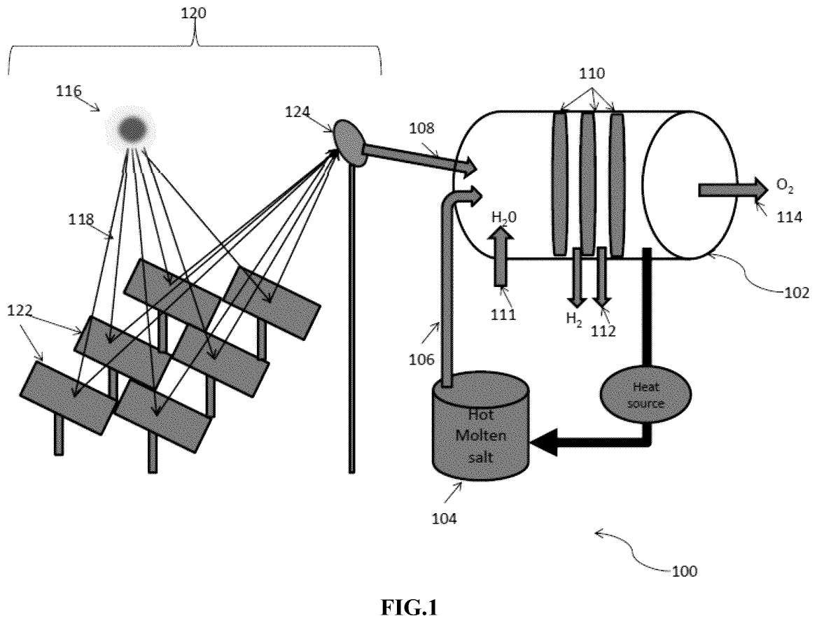

FIG. 1 illustrates an exemplary contemplated embodiment of a hydrogen production system 100 disclosed herein. In this exemplary embodiment, excess thermal energy (relative to the energy requirements of the catalytic reaction) is absorbed and stored in a molten salt heat transfer fluid. An optional further heat source (e.g., where the plant is co-located with another plant that produces waste heat such as a smelting, gasification, gas-or coal fired power plant, etc., or a plant that recovers other heat such as geothermal heat, volcanic heat, etc.) may be implemented to provide thermal energy to the heat transfer fluid. The hydrogen production system 100 comprises a first catalytic reactor 102, a thermal energy storage circuit 104; and a heat exchanger 106 thermally coupled to the thermal energy storage circuit 104 and the first catalytic reactor 102, wherein the first catalytic reactor 102 has a solar energy receiving portion 108 and a first catalyst assembly 110 that is capable of catalytically dissociating steam 111 into H₂ 112 and O₂ 114, and wherein the heat exchanger 106 is configured to provide thermal energy from the thermal energy storage circuit 104 to the first catalytic reactor 102.

Solar energy used in the system is collected in a solar heliostat system 120, which receives solar radiation 118 from the sun 116 onto a plurality of heliostats 122 that reflect the light to a solar heat collector 124. Using heliostats 122 to reflect focused sunlight onto the solar heat collector 124, the solar heliostat system can generate very high temperatures, up to 2,000 ° C. This solar energy is transferred to the first catalytic reactor 102 via the solar energy receiving portion 108 and used for dissociating steam into hydrogen and oxygen.

As noted above, the heat generated by the solar heliostat system 120 may be more than what is needed for the catalytic dissociation of steam into hydrogen and oxygen. In those instances, the excess energy is diverted for heating molten salt, and the heated molten salt is stored in the thermal energy storage circuit 104. In some embodiments, the system can include one or more sensor that detect differential temperatures between the molten salt and steam chamber. When a differential temperature is detected, the sensors trigger an energy redirector to ensure the excess thermal energy is diverted to where it is most needed; for retaining heat in the molten salt or for maintain temperature of the steam. Within the heliostat system, an energy redirector may include one or more mirrors, prisms, or other optical circuit elements operating alone, in combination, or as a constellation. As will be readily appreciated, the heliostat system may be oversized relative to the energy demand for daytime hydrogen production to deliver excess solar thermal energy, and the amount of excess solar thermal energy can be matched to a specific quantity. For example, the heliostat may be sized and dimensioned such as to provide the entire energy demand for the operational period where sunlight is not available to satisfy the energy demand for hydrogen production in a 24 hour/day continuous operation. However, less excess energy may also be suitable for situations where a waste heat source (FIG. 1, heat source) can provide at least some energy to heat the molten salt.

In a preferred embodiment, molten salt is used for storing thermal energy in the thermal energy storage circuit 104. The molten salt used herein for the steam dissociation reaction is capable of being heated to high temperatures, for example, to a temperature of at least approximately 1200 degrees Fahrenheit (° F.), preferably at least approximately 1500° F., more preferably at least approximately 1700° F., more preferably at least approximately 1800° F., and most preferably at least approximately 2000° F. Molten salts exhibit many desirable heat transfer qualities at high temperatures. They have high density, high heat capacity, high thermal stability, and low vapor pressure even at elevated temperatures. Furthermore, their viscosity is low enough for sufficient pumping at high temperatures, and many salts are compatible with common stainless steels.

The molten salt can be salts composed of alkaline earth fluorides and alkali metal fluorides, and combinations thereof. Suitable elements of the molten salt include: Lithium (Li), Sodium (Na), Potassium (K), Rubidium (Rb), Cesium (Cs), Francium (Fr), Beryllium (Be), Magnesium (Mg), Calcium (Ca), Strontium (Sr), Barium (Ba), Radium (Ra), and Fluorine (F). Examples of suitable fluoride molten salts include, but are not limited to: FLiNaK, FLiBe, FLiNaBe, FLiKBe, and combinations thereof. A commonly available thermal salt includes an eutectic mixture of sodium nitrate and potassium nitrate. Those skilled in the art will appreciate other suitable components may be used for obtaining comparable physical properties of the molten salt.

While molten salt is a preferred embodiment, it should be appreciated that the thermal energy storage circuit may receive and store thermal energy from a variety of sources, for example, waste heat from a foundry, an oil refinery, a steelmaking plant, a power plant, a heated gas energy source, and/or a solar energy source.

The steam dissociation reaction occurs in the catalytic reactor 102 in the presence of a catalyst assembly 110. A variety of catalysts are capable of dissociating steam at high temperatures, as is known in the art. Exemplary catalysts include, but are not limited to, Cerium dioxide (CeO2, Ceria), Strontium titanate (SrTiO₃), and/or Titanium dioxide (TiO2).

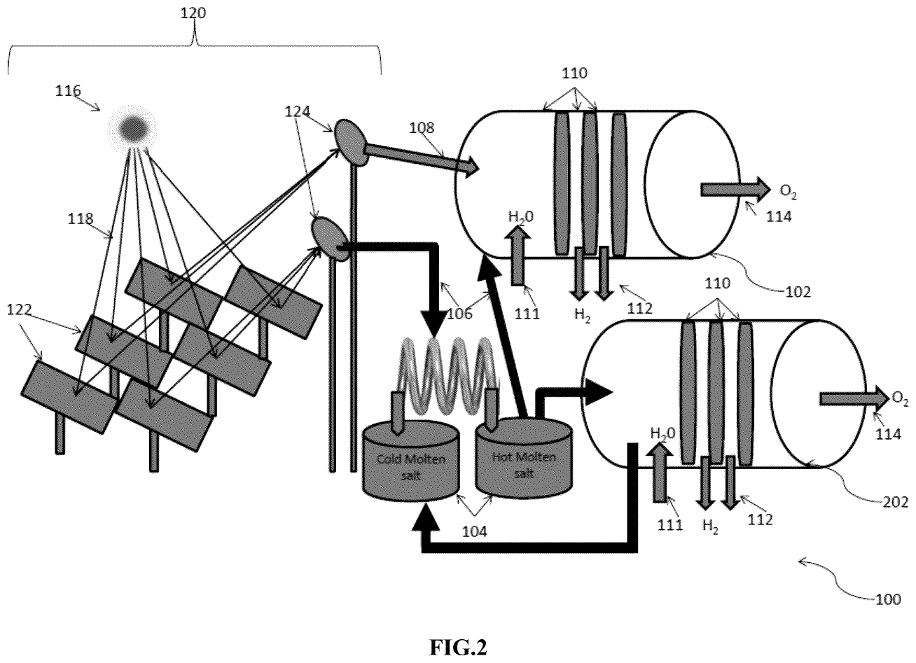

FIG. 2 illustrates another exemplary contemplated embodiment of the hydrogen production system 100 disclosed herein. In this embodiment, a second catalytic reactor 202 is operationally coupled to the first catalytic reactor 102, and the energy demand for the steam dissociation in the second reactor is exclusively provided by a thermal energy storage circuit. The thermal energy storage circuit 104 is operationally coupled with both the first catalytic reactor 102 and second catalytic reactor 202. In this embodiment, there are two solar heat collectors 124, wherein one heat collector provides solar energy to the first catalytic reactor and the second heat collector provides heat energy to heat the molten salt to a temperature between 1000° F. and 2000° F. In this embodiment daytime production of hydrogen takes place in the first catalytic reactor 102 and nighttime production of hydrogen takes place in either the first catalytic reactor 102 or the second catalytic reactor 202. With respect to the remaining numerals, the same considerations as described in FIG. 1 apply.

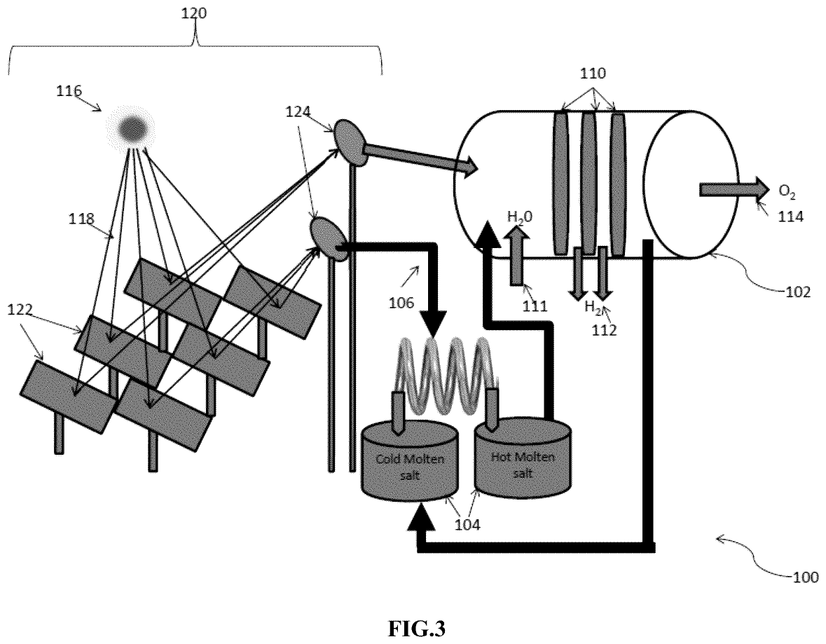

FIG. 3 illustrates yet another exemplary embodiment of the hydrogen production system disclosed herein. In this embodiment, which represents a hybrid configuration of the systems of FIGS. 1 and 2, the cooler molten salt is heated to a temperature of 1000° F. to 2000° F. by a solar heat collector 124 during the daytime and the hot molten salt is stored in the thermal energy storage unit, 104. At nighttime, when the solar energy is not sufficient to run the first catalytic reactor 102 at a temperature between 1000° F. and 2000° F., the catalytic reactor 102 is heated with thermal energy from the thermal energy storage unit 104.

Most typically, as will be readily appreciated, one or more heat exchangers may be thermally coupled to the system to so allow for exchange of thermal energy. For example, suitable heat exchangers include tube-in-shell exchangers, plate fin heat exchangers, coiled heat exchangers, etc., and the proper choice of the heat exchanger will at least in part depend on the location. For example, where excess heat is drawn from the first catalytic reactor or the solar energy receiving portion, the heat exchanger may be a plate fin heat exchanger or a coiled heat exchanger. On the other hand, where the excess heat is drawn from a second solar heat collector 124 as described below, the heat exchanger may be a coiled heat exchangers. Likewise, where heat from the molten salt is provided to the steam, the heat exchanger may be a tube in shell type heat exchanger. On the other hand, where heat from the molten salt is provided to the catalytic reactor, the heat exchanger may be a finned plate heat exchanger.

Therefore, it should be appreciated that the heat exchange can occur in a single heat exchange device for receiving from and providing heat to the thermal energy storage circuit (especially in configurations according to FIG. 1), or in separate exchangers (especially in configurations according to FIGS. 2 and 3). Consequently, and viewed from a different perspective, it should be recognized that the heat from the thermal energy circuit may be provided to heat the steam, the catalyst bed, and/or the reactor vessel. Likewise, the heat may be received in the thermal energy circuit from excess solar radiation that is diverted from at least some of the heliostats, from excess heat within the catalytic reactor, and/or from an external heat source (preferably providing waste heat).

Thus, by using the systems disclosed herein and shown in FIGS. 1-3, hydrogen gas can be produced in a continuous manner. In one embodiment, the present disclosure provides a method of continuously producing hydrogen, comprising: producing hydrogen during daytime by utilizing heat from a solar energy source to catalytically dissociate steam into H₂ and O₂ in a first catalytic reactor; and producing hydrogen during nighttime by utilizing heat stored in a thermal energy storage circuit to catalytically dissociate steam into H₂ and O₂. Moreover, it should be appreciated that existing solar hydrogen production facilities may be retrofitted to include a thermal energy storage circuit and/or a second catalytic reactor.

Furthermore it should be appreciated that the hydrogen production system disclosed herein may be used in conjunction with other useful systems. For example, as is known in the art, sunlight is broken down into three major components: (1) visible light, (2) ultraviolet light, and (3) infrared radiation. The visible portion constitutes nearly half of the radiation received at the surface of the earth, while the infrared radiation has its chief merit in its heat producing quality. In one embodiment, it is contemplated that the solar heliostat system 100 as disclosed herein may also be useful in conjunction with a daylighting system for providing illumination to the interior of a building using solar energy as a source of light. In this embodiment, it is contemplated that the infrared radiation portion of the sunlight is used for its heat producing quality to produce hydrogen using the system 100 disclosed herein, while the visible portion of the sunlight is channeled as concentrated light beams and distributed throughout places of use in the building.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. Where the specification claims refers to at least one of something selected from the group consisting of A, B, C . . . and N, the text should be interpreted as requiring only one element from the group, not A plus N, or B plus N, etc.

What is claimed is:

1. A method of continuously producing hydrogen (H₂) gas, the method comprising:
providing a system comprising a catalytic reactor that is operationally coupled to a thermal energy storage circuit, wherein the catalytic reactor has a solar energy receiving portion for receiving solar energy from sunlight and a catalyst assembly, and wherein the thermal energy storage circuit receives solar energy and stores the solar energy in molten salts, and continuously producing H₂ gas for at least 16 hours per day by the process of:
a) in the presence of sunlight, using the received solar energy in the catalytic reaction for catalytically dissociating steam into H₂ and O₂, and
b) in the absence of sunlight, using energy stored in the molten salts for catalytically dissociating steam into H₂ and O₂.

2. The method of claim 1, wherein the hydrogen production system further comprises a second catalytic reactor.

3. The method of claim 2, wherein the second catalytic reactor receives thermal energy from the thermal energy storage circuit for catalytically dissociating steam into H₂ and O₂

4. The method of claim 1, wherein the thermal energy storage circuit is operatively coupled to a solar energy receiver.

5. The method of claim 1, wherein the thermal energy storage circuit is further adapted to receive and store thermal energy from waste heat from a foundry, an oil refinery, a steelmaking plant, a power plant, and/or a heated gas energy source.

6. The method of claim 1, wherein the molten salt comprises salts composed of alkaline earth fluorides and alkali metal fluorides, or combinations thereof.

7. The method of claim 1, further comprising a solar energy source that is configured to provide solar energy to the solar energy receiving portion of the first catalytic reactor and wherein the solar energy source is further configured to divert a portion of solar energy to the thermal energy storage circuit.

8. The method of claim 1, wherein the catalytic reactor operates at a temperature of 1000° F. to 2000° F. for dissociation of steam into H₂ and O₂

9. The method of claim 1, wherein the catalytic reactor comprises cerium dioxide (CeO₂), strontium titanate (SrTiO3), and/or titanium dioxide (TiO2).

10. A method of continuously producing hydrogen, comprising:
a) producing hydrogen during daytime by utilizing heat from a solar energy source to catalytically dissociate steam into H2 and O2 in a first catalytic reactor; and
b) producing hydrogen during nighttime by utilizing heat stored in a thermal energy storage circuit to catalytically dissociate steam into H₂ and O₂, wherein the thermal energy storage circuit receives solar energy and stores the solar energy in molten salts, wherein the molten salt to capture waste heat from the solar heliostat system and uses the captured waste heat to produce H2 gas when the sun is not available.

11. The method of claim 10, wherein nighttime hydrogen production is at the first catalytic reactor, and wherein the heat stored in the thermal energy storage circuit is transferred to the first catalytic reactor by a heat exchanger.

12. The method of claim 10, wherein nighttime hydrogen production is in a second catalytic reactor, and wherein the heat stored in the thermal energy storage circuit is transferred to the second catalytic reactor by a heat exchanger.

13. The method of claim 10, wherein the first catalytic reactor has a solar energy receiving portion and a first catalyst assembly that is capable of catalytically dissociating steam into H2 and O2.

14. The method of claim 12, wherein the second catalytic reactor has a second catalyst assembly that is capable of catalytically dissociating steam into H₂ and O₂.

15. The method of claim 10, wherein the thermal energy storage circuit receives and stores thermal energy from waste heat from a foundry, an oil refinery, a steelmaking plant, a power plant, a heated gas energy source, and/or a solar energy source.

16. The method of claim 10, wherein the solar energy source diverts a portion of the solar energy to a heat exchanger that heats the thermal energy storage circuit.

17. The method of claim 16, wherein the heat exchanger is an integral part of the first and/or second catalytic reactor for heating steam to temperatures of 1000° F. to 2000° F.
